(19) United States
(12) Patent Application Publication
(10) Pub. No.: US 2022/0143804 A1
(43) Pub. Date: May 12, 2022

(54) PIVOTAL STRUCTURE FOR DRIVING HEAD OF WRENCH

(71) Applicant: Yi-Fu Chen, Taichung City (TW)

(72) Inventor: Yi-Fu Chen, Taichung City (TW)

(21) Appl. No.: 17/584,269

(22) Filed: Jan. 25, 2022

Related U.S. Application Data
(63) Continuation-in-part of application No. 16/836,937, filed on Apr. 1, 2020.

(51) Int. Cl. B25G 1/06; B25G 1/10

(52) U.S. Cl. CPC B25G 1/063; B25G 1/105

(57) ABSTRACT

A wrench includes a handle and a working end, two arms extend from the working end to form a room between the two arms. Each arm includes a locking hole. A driving head is pivotably connected between the two arms. Two bolts are respectively and threadedly connected to the locking holes of the two arms, and inserted into the two recesses of the driving head to pivotably position the driving head. A wave washer is mounted to each of the two bolts and sandwiched between the driving head and the arm. The convex portions one side of each wave washer contact the outside of the driving head. The convex portions on other side of each wave washer contact the inside of the arm corresponding thereto. The friction between the driving head and the arms is reduced when the driving head is pivoted relative to the arms.

### BACKGROUND OF THE INVENTION

### 1. Fields of the Invention

The present invention is a Continuation-In-Part patent application of applicant's former patent application with application No. 16/836,937, filed on Apr. 1, 2020.

### 2. Descriptions of Related Art

The conventional wrench 6 known to applicant is disclosed in FIGS. 6 and 7, and includes a working end formed to one end of a handle, a driving head 7 pivotably connected between two arms 61 extending from the working end of the wrench 6. A pin 8 extends through the two arms 61 and the driving head 7 so as to pivotably connect the driving head 7 to the two arms 61. A slot 62 is defined axially in the working end of the wrench 6 and provides a proper flexibility to the two arms 61 when installing the driving head 7 to the two arms 61, or removing the driving head 7 from the two arms 61. However, the manufacturing cost for the slot 62 makes the wrench have less competition on price. The slot 62 also weakens the strength of the working end of the wrench 6 so that the working end may be deformed. Furthermore, the pin 8 has to be made by high strength material because the pin 8 bears high stress during operation of the wrench 6.

FIG. 8 discloses another wrench wherein the driving head has two recesses 71 respectively defined in outside of the driving head, and two bolts 9 extend through the two arms 61 and are threadedly connected to the recesses 71. A washer 10 is located in each recess 71 and the distal end of the bolt 9 contacts against the washer 10 to provide secure connection between the bolt 9 and the recess 71. Nevertheless, the bolts 9 tend to loosen relative to the driving head after frequent uses, and once the bolts 9 loosen, the driving head is not well positioned. In addition, the washers 10 fail to secure the connection between the bolt 9 and the recess 71 once the bolts 9 loosen. The washers 10 are small and easily lost during assembling steps.

The present invention intends to provide a pivotal structure for a driving head of a wrench to eliminate the shortcomings mentioned above.

### SUMMARY OF THE INVENTION

The present invention relates to a wrench and comprises a handle and a working end which is formed to one end of the handle. Two arms extend from the working end and a room is formed between the two arms. Each arm has a locking hole defined therethrough. A driving head has two recesses defined in the outside thereof, and the two recesses are located corresponding to the two locking holes of the two arms. Two bolts are respectively and threadedly connected to the locking holes in the two arms, and are inserted into the two recesses of the driving head to pivotably position the driving head between the two arms. A wave washer is mounted to each of the two bolts and sandwiched between the driving head and the arm. Each of the wave washers includes multiple convex portions and multiple concaved portions formed to each of two sides thereof. The multiple convex portions and the multiple concaved portions are located alternatively to each other. The convex portions of one of two sides of each of the wave washers partially contact the outside of the driving head, and the convex portions of another one of the two sides of each of the wave washers partially contact the inside of the arm corresponding thereto.

The primary object of the present invention is to provide a wrench wherein the bolts do not loosen by mounting a wave washer to each bolt, and the wave washer is sandwiched between the driving head and the arm.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is an exploded view of the wrench of the present invention;

FIG. 3 is a cross sectional view, taken along line III-III in FIG. 1;

FIG. 4 is a cross sectional view, taken along line IV-IV in FIG. 1;

FIG. 5 is an enlarged cross sectional view to show that the wave washer is sandwiched between the arm and the diving head;

FIG. 6 is an exploded view of a conventional wrench;

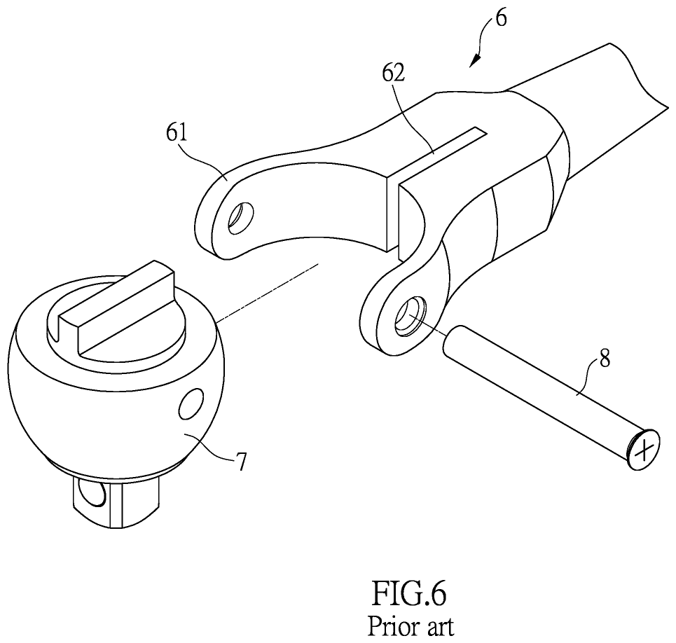

FIG. 7 is a top view of the conventional wrench in FIG. 6, and

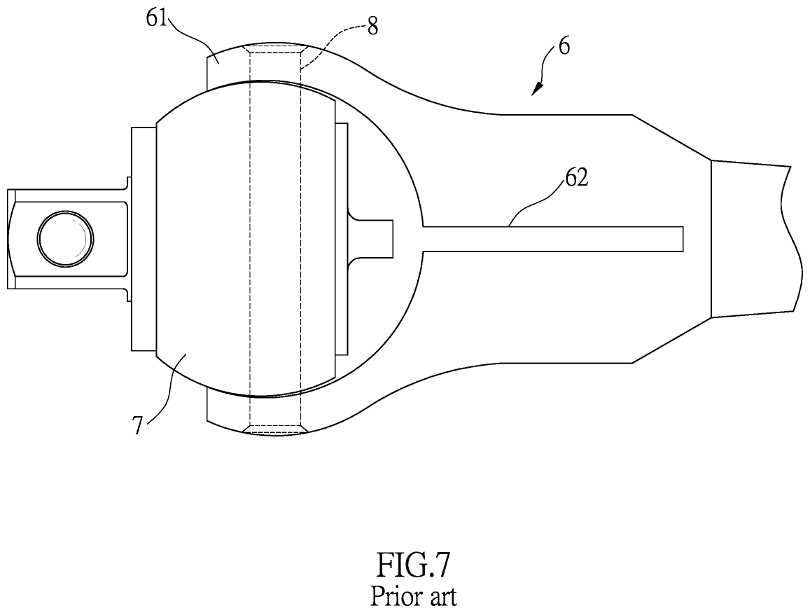

FIG. 8 is a partial cross sectional view of another conventional wrench.

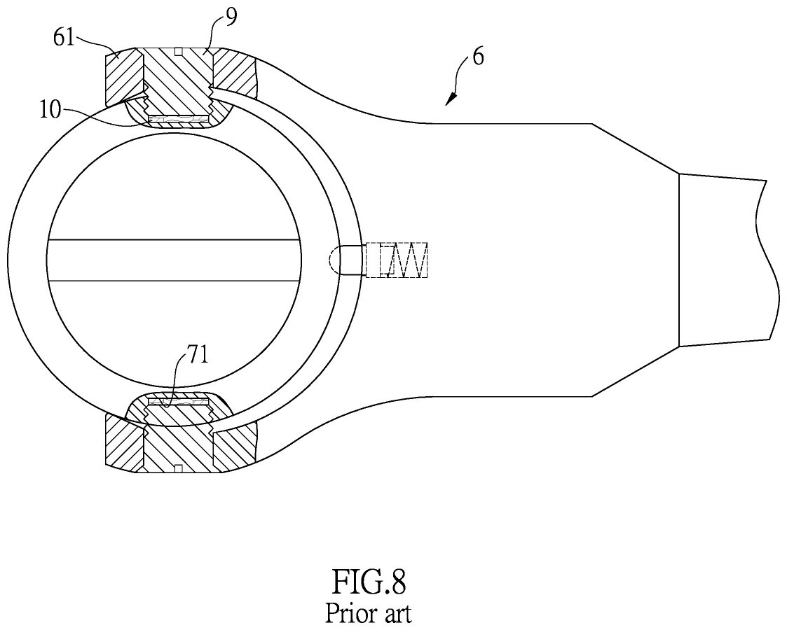

### DETAILED DESCRIPTION OF THE PREFERRED EMBODIMENT

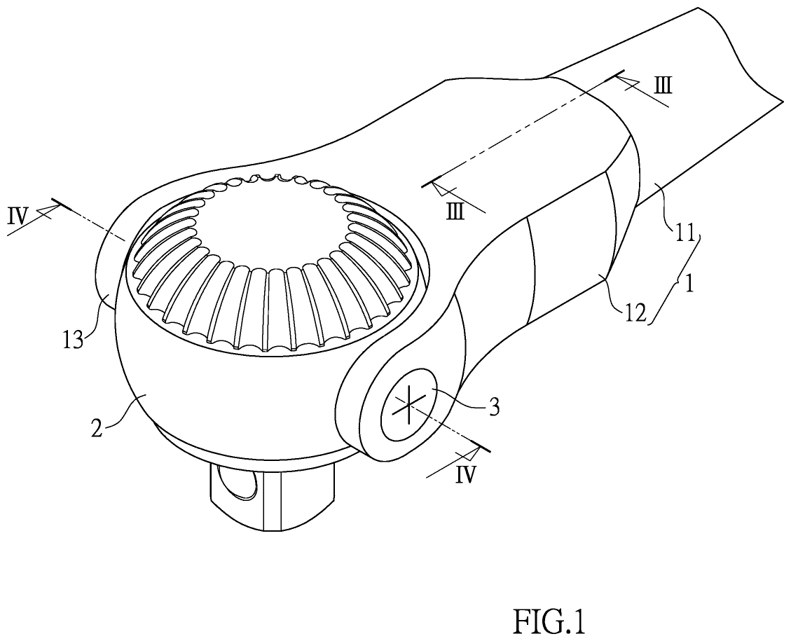

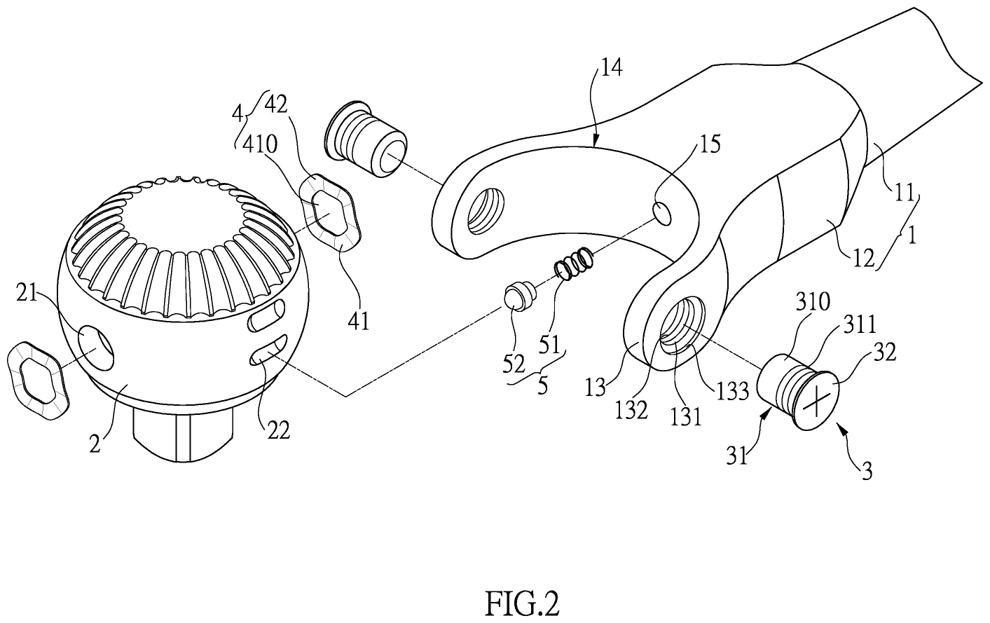

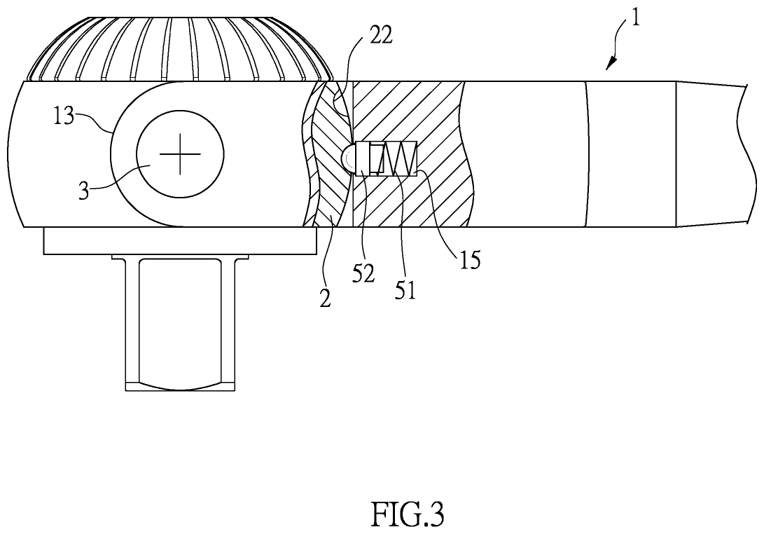

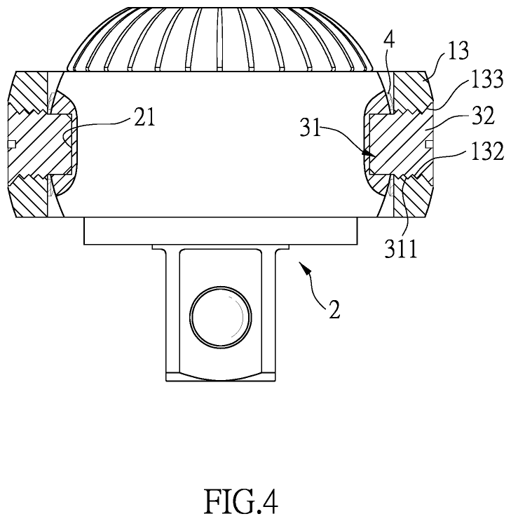

Referring to FIGS. 1 to 5, the wrench 1 of the present invention comprises a handle 11 and a working end 12 which is formed to one end of the handle 11. Two arms 13 extend from the working end 12 and a room 14 is formed between the two arms 13. Each arm 13 includes a locking hole 131 defined therethrough, and the two locking holes 131 of the two arms 13 are located corresponding to each other. Each locking hole 131 includes inner threads 132. Each of the arms 13 includes a reception area 133 which coaxially communicates with the locking hole 131 corresponding thereto.

A driving head 2 includes two recesses 21 defined in its outside thereof, and the two recesses 21 are located corresponding to the two locking holes 131 of the two arms 13. Specifically, the outside of the driving head 2 is a rounded convex surface, a driving portion extends from the bottom of the driving head 2 so as to be connected with a socket or the like. The two recesses 21 are defined in the rounded convex surface of the driving head 2. Two bolts 3 are respectively and threadedly connected to the locking holes 131 in the two arms 13 and inserted into the two recesses 21 of the driving head 2 to pivotably position the driving head 2 between the two arms 13. Specifically, each of the two bolts 3 includes a shank 31 and a head 32 which is formed to one end of the shank 31. The shank 31 of each bolt 3 includes a blank section 310 and a function section, wherein the function section includes outer threads 311 formed thereto. The blank section 310 is located in the recess 21 corresponding thereto. The outer threads 311 of the bolt 3 are threadedly connected to the inner threads 132 in the locking hole 131.

A wave washer 4 is mounted to the shank 31 of each of the two bolts 3 and sandwiched between the driving head 2 and the arm 13. The head 32 of each bolt 3 is accommodated in the reception area 133 corresponding thereto and in flush with outside of the arm 13. Each of the wave washers 4 has an outer diameter “D”, and each recess 21 includes an inner diameter “d” which is smaller than the outer diameter “D” of the wave washer 4. Therefore, the wave washers 4 do not drop into the recesses 21.

The wave washers 4 are used to reduce friction between the driving head 2 and the arms 13. In addition, the wave washers 4 also enhance the connection between the bolts 3 and the locking holes 131 of the arms 13 to position the driving head 2. Besides, the assembling steps of the wrench 1 of the present invention become easier because the wave washers 4 are larger than those of the conventional wrenches mentioned before. The driving head 2 is first located between the two arms 13, and the wave washers 4 are respectively positioned between the driving head 2 and the arms 13. The bolts 3 easily extend through wave washers 4 after the bolts 3 extend through the locking holes 131 of the arms 3. The distal end of each bolt 3 is inserted into the recess 21 of the driving head 2 corresponding thereto, until the two sides of each wave washer 4 is sandwiched between the driving head 2 and the arm 13.

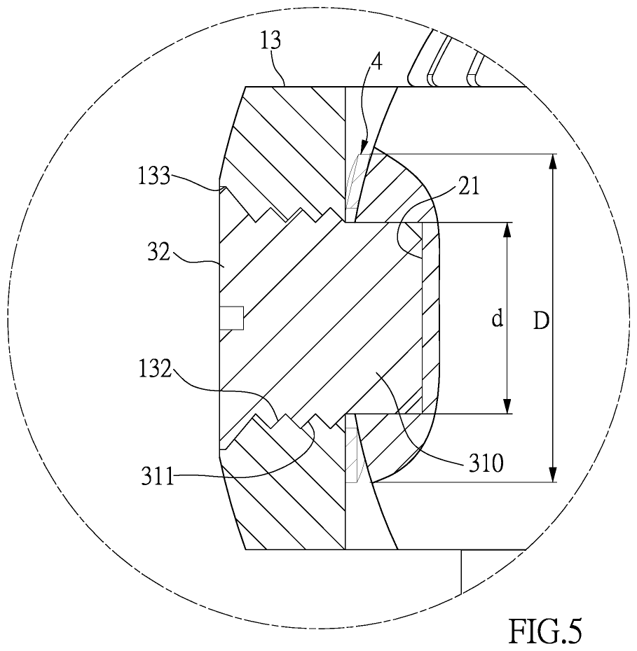

Each of the wave washers 4 includes multiple convex portions 41 and multiple concaved portions 42 formed to each of two sides thereof. The multiple convex portions 41 and the multiple concaved portions 42 are located alternatively to each other. The convex portions 41 of one of two sides of each of the wave washers 4 partially contact the outside of the driving head 2, and the convex portions 41 of another one of the two sides of each of the wave washers 4 partially contact the inside of the arm 13 corresponding thereto as shown in FIG. 5. Therefore, by less contact area between the wave washers 4 and the driving head 2 and the arms 13, the friction between the driving head 2 and the arms 13 is reduced when the driving head 2 is pivoted relative to the arms 13.

An aperture 15 is defined in an inner end of the room 14 and located between the two arms 13. A positioning unit 5 is located in the aperture 15 and includes a spring 51 and a bead 52. The spring 51 is biased between the inner end of the aperture 15 and the spring 51. The bead 52 partially protrudes beyond the aperture 15. The driving head 2 includes multiple positioning holes 22 defined in the outside thereof. The positioning holes 22 are located in the pivotal direction of the driving head 21 relative to the working end 12, so that the bead 52 is engaged with one of the positioning holes 22 to secure the pivotal position of the driving head 21 relative to the working end 12.

While we have shown and described the embodiment in accordance with the present invention, it should be clear to those skilled in the art that further embodiments may be made without departing from the scope of the present invention.

What is claimed is:

1. A wrench comprising:
a handle and a working end which is formed to one end of the handle, two arms extending from the working end and a room formed between the two arms, each arm having a locking hole defined therethrough;
a driving head having two recesses defined in an outside thereof, the two recesses located corresponding to the two locking holes of the two arms, and
two bolts respectively and threadedly connected to the locking holes in the two arms and inserted into the two recesses of the driving head to pivotably position the driving head between the two arms, a wave washer mounted to each of the two bolts and being sandwiched between the driving head and the arm, each of the wave washers including multiple convex portions and multiple concaved portions formed to each of two sides thereof, the multiple convex portions and the multiple concaved portions located alternatively to each other, the convex portions of one of two sides of each of the wave washers partially contacting the outside of the driving head, the convex portions of another one of the two sides of each of the wave washers partially contacting an inside of the arm corresponding thereto so that a friction between the driving head and the arms is reduced when the driving head is pivoted relative to the arms.

2. The wrench as claimed in claim 1, wherein each of the two bolts includes a shank and a head which is formed to one end of the shank, the shank includes outer threads, each locking hole includes inner threads, the outer threads of the bolt are threadedly connected to the inner threads in the locking hole.

3. The wrench as claimed in claim 2, wherein each of the arms includes a reception area which communicates with the locking hole corresponding thereto, the head of each bolt is accommodated in the reception area corresponding thereto and in flush with outside of the arm.

4. The wrench as claimed in claim 1, wherein each of the wave washers has an outer diameter, each recess includes an inner diameter which is smaller than the outer diameter of the wave washer.

5. The wrench as claimed in claim 1, wherein an aperture is defined in an inner end of the room and located between the two arms, a positioning unit is located in the aperture and includes a spring and a bead, the spring is biased between an inner end of the aperture and the spring, the bead partially protrudes beyond the aperture, the driving head includes multiple positioning holes defined in the outside thereof, the positioning holes are located in a pivotal direction of the driving head relative to the working end, the bead is engaged with one of the positioning holes to secure a pivotal position of the driving head relative to the working end.

6. The wrench as claimed in claim 2, wherein each shank of each bolt includes a blank section and a function section, the function section includes the outer threads formed thereto, the blank section is located in the recess corresponding thereto.

7. The wrench as claimed in claim 1, wherein the outside of the driving head is a rounded convex surface, the two recesses are defined in the rounded convex surface of the driving head.
